(19) United States
(12) Patent Application Publication
(10) Pub. No.: US 2018/0259129 A1
(43) Pub. Date: Sep. 13, 2018

(54) Pressure Vessel Comprising a Domed Cap, and Method for Manufacturing a Pressure Vessel

(71) Applicant: Bayerische Motoren Werke Aktiengesellschaft, Muenchen (DE)

(72) Inventor: Timo CHRIST, Muenchen (DE)

(21) Appl. No.: 15/977,433

(22) Filed: May 11, 2018

Related U.S. Application Data
(63) Continuation of application No. PCT/EP2016/073890, filed on Oct. 6, 2016.

(30) Foreign Application Priority Data
Nov. 13, 2015 (DE) 10 2015 222 391.4

(51) Int. Cl. F17C 13/06; F17C 1/06; F17C 13/08

(52) U.S. Cl. CPC F17C 13/06; F17C 1/06; F17C 13/084; F17C 2201/0109; F17C 2203/0604; F17C 2203/0619; F17C 2270/0168; F17C 2203/066; F17C 2203/0663; F17C 2205/0192; F17C 2205/0305; F17C 2221/012; F17C 2203/0636

(57) ABSTRACT

A pressure vessel for storing fuel includes a liner for storing the fuel, a fiber-reinforced layer that surrounds at least some areas of the liner, and at least one domed cap which at least partially covers an end of the liner. Connection pins project from the surface of the domed cap. The connection pins protrude from the fiber-reinforced layer.

### CROSS REFERENCE TO RELATED APPLICATIONS

This application is a continuation of PCT International Application No. PCT/EP2016/073890, filed Oct. 6, 2016, which claims priority under 35 U.S.C. § 119 from German Patent Application No. 10 2015 222 391.4, filed Nov. 13, 2015, the entire disclosures of which are herein expressly incorporated by reference.

### BACKGROUND AND SUMMARY OF THE INVENTION

The technology disclosed herein relates to a pressure vessel having a dome cap, and to a method for producing such a pressure vessel.

Pressure vessels expand in a manner which is dependent on factors such as the interior pressure p or the temperature T of the pressure vessel. For this reason, pressure vessels are attached to the vehicle body of a motor vehicle in accordance with the locating bearing/floating bearing principle. A construction of this type requires a relatively large amount of installation space. Moreover, it is not capable of transmitting forces and torques from one end of a pressure vessel to another end of the pressure vessel. Said pressure vessels therefore do not contribute or contribute only to a small extent to the rigidity of the vehicle body.

DE 19935516 A1 discloses a cylinder for pressurized gases having a holding ring flange at the respective ends of the cylinder. Furthermore, DE 10 2010 053 874 A1 discloses a holding system for a pressure vessel having two securing caps.

It is an object of the technology which is disclosed herein to reduce or to eliminate the disadvantages of the previously known solutions. In particular, it is an object of the technology which is disclosed herein to provide easier and more compact ways for integrating a pressure vessel in a vehicle, it being possible, in particular, for this to be a load-bearing pressure vessel. Further objects result from the advantageous effects of the technology which is disclosed herein.

These and other objects are achieved by way of a pressure vessel, and a method for producing same, for storing fuel, comprising: a liner for storing fuel; a fiber-reinforced layer surrounding at least some areas of at least one dome cap which at least partially covers one end of the liner; and connecting pins projecting from the surface of the dome cap, the connecting pins protruding out of the fiber-reinforced layer.

The technology which is disclosed herein relates to a pressure vessel for storing fuel for a motor vehicle. A pressure vessel of this type can be, for example, a cryogenic pressure vessel or a high pressure gas vessel.

High pressure gas vessels are configured to store fuel (for example hydrogen) substantially at ambient temperatures over the long term at a maximum operating pressure (also called MOP) of over approximately 350 bar(g), further preferably over approximately 500 bar(g) and particularly preferably over approximately 700 bar(g). High pressure gas vessels are defined, for example, in the standard EN13445. Type III and type IV pressure vessels have, for example, an inner liner made from aluminum and from plastic, respectively, and a fiber-reinforced layer. Liner-less pressure vessels can also be provided.

A cryogenic pressure vessel can store fuel in the liquid or supercritical physical state. A thermodynamic state of a substance, which thermodynamic state is at a higher temperature and at a higher pressure than the critical point, is called a supercritical physical state. A cryogenic pressure vessel is suitable, in particular, to store the fuel at temperatures which lie considerably below the operating temperature (that temperature range of the vehicle environment is meant, in which the vehicle is to be operated) of the motor vehicle, for example at least 50 Kelvin, preferably at least 100 Kelvin or at least 150 Kelvin below the operating temperature of the motor vehicle (as a rule from approximately −40° C. to approximately +85° C.). The fuel can be, for example, hydrogen which is stored in the cryogenic pressure vessel at temperatures of approximately from 34 K to 360 K.

In order to obtain a pressure vessel with a stress distribution which is as favorable as possible and with regard to the vehicle integration, an elongate pressure vessel with curved (preferably semi-elliptical) pole caps at the two lateral ends (also called domes) is favorable. A pressure vessel of this type can be integrated, for example, centrally in the vehicle tunnel.

The pressure vessel which is disclosed herein for storing fuel in a motor vehicle comprises a liner and a fiber-reinforced layer which surrounds the liner at least in regions. Fiber-reinforced plastics (FRP) are used as a fiber-reinforced layer or encapsulation or reinforcement (in the following text, the term “fiber-reinforced layer” is mostly used), for example carbon fiber reinforced plastics (CFRP) and glass fiber reinforced plastics (GFRP). The FRP structure of a pressure vessel has a reinforcing effect as a result of fibers which are embedded in a plastic matrix. An FRP comprises fibers and matrix material which should be combined in a load-oriented manner, in order that the desired mechanical and chemical properties result. The fiber-reinforced layer is, as a rule, a layer which has cross-laid plies and circumferential plies. As a rule, they handle the entire stresses which result from the interior pressure. In order to compensate for axial stresses, cross-laid plies are wound or woven over the entire liner surface. What are known as the circumferential plies which ensure a reinforcement in the tangential direction are situated in the cylindrical shell region M. The circumferential plies run in the circumferential direction U of the pressure vessel. The circumferential plies are oriented at a 90° angle with respect to the pressure vessel longitudinal axis A-A.

The technology which is disclosed herein likewise relates to a liner for a pressure vessel for storing fuel. The liner can be produced from a metal, from a metal alloy or from a plastic. For example, a liner made from aluminum or an aluminum alloy is expedient. The fuel is stored in the liner, and the liner is as a rule responsible for the tightness of the pressure vessel. If, for example, hydrogen is stored, the liner is, as a rule, configured to avoid hydrogen permeation. In addition, the liner as a rule serves as a wound and/or woven core. A metallic embodiment can be designed both in a load-bearing manner and, like a polymer liner, in a non-load-bearing manner. The liner contour is usually selected to be as thin as possible, since the strength of the fiber composite is substantially higher and therefore a thinner overall wall thickness can be achieved. For example, the maximum wall thickness of the liner can be less than 20 mm, preferably less than 10 mm or 5 mm. Just like the pressure vessel, the liner also as a rule has an elongate shape with curved pole caps. The pole caps and the cylindrical shell region M which is arranged in between are, in particular, advantageously shaped in one piece. An opening is provided in at least one of the pole caps of the liner.

A stub (also called a port) is provided at the opening of the liner. The port is, as a rule, produced from a steel alloy or aluminum alloy. The port is advantageously covered at least partially by the fiber-reinforced layer. The port can serve to connect any fuel lines to the pressure vessel. The port can have, for example, a port collar or neck (in the following text, the term “neck” is used for the sake of simplicity), to which a fuel line can be flange-connected. To this end, further components can be inserted into the port, for example by way of an internal thread. At the end which lies opposite the neck, a connecting section of widening configuration can be provided, which connecting section advantageously has the same contour at least in regions as the pole cap of the liner. Said connecting section preferably lies on the liner.

The technology which is disclosed herein comprises, furthermore, at least one dome cap which covers an end of the liner at least partially. In other words, a curved dome cap covers a dome of the liner at least partially. The dome cap can be produced from a metal, from a (fiber-reinforced) plastic or from a metal alloy. The dome cap expediently has a cap opening, out of which a port or a blind boss of the pressure vessel can be guided. In particular, the dome cap can extend from the neck as far as the transition region Ü from the dome to the cylindrical region of the pressure vessel. Here, the transition region Ü can be the region, in which the liner already has at least 80%, preferably at least 90%, of the mean diameter which the liner has in the (substantially) cylindrical shell region M. The dome cap can be configured, for example, as a solid material, for example as an annular plate or clamp. For example, the dome cap can have cutouts. The cutouts which are provided in the dome cap can advantageously be designed in such a way that a framework structure is produced. Furthermore, it is contemplated that a wire structure (for example, wire mesh) or a lattice structure configures the curved (surface) area of the dome cap, from which connecting pins or bolts extend away. The framework might also be realized in a different way than by way of stamped-out portions. The framework and/or the wire or lattice structure can be based, for example, on a metallic material and/or on a fiber composite material. Here, the wires, lattices and/or fibers are advantageously oriented in such a way that, in the case of the transmission of forces and/or torques between the connecting pins and the bolts (see below), they act in accordance with the principle of tension rods or pressure rods. The load ring itself preferably comprises at least one laminate layer made from a fiber-reinforced plastic. The fibers of at least one (in particular, uni-directional) ply of the laminate layer are preferably arranged in the circumferential direction (hoop plies). Further plies of the laminate layer can be oriented in a different way. Plies of this type which are oriented in the circumferential direction U can be realized only with difficulty during winding or weaving around the pressure vessel at the pole caps. A laminate layer which is designed in this way can be produced comparatively inexpensively beforehand separately from the pressure vessel. The laminate layer can firstly transmit the forces and/or torques between the connecting pins and bolts, and secondly can also support the fiber-reinforced layer in the pole regions with regard to the forces which result from the vessel interior pressure.

Connecting pins project from the surface of the dome cap in a manner which is directed outward. The connecting pins project or protrude out of the fiber-reinforced layer toward the pressure vessel exterior. A dome cap can have at least two, preferably at least four connecting pins. In particular, the connecting pins can be configured and arranged in such a way that reinforcing fibers of the fiber-reinforced layer can still run between two connecting pins which are adjacent. In this way, the dome cap can be wound around or woven around simply. Furthermore, the forces and torques which are transmitted by the vehicle body can be introduced into the fiber-reinforced layer in an improved manner. Stress peaks are reduced here. The connecting pins can be fastened to the dome cap in an integrally joined manner, for example by way of welding, adhesive bonding, soldering and/or overmolding. The connecting pins and the dome cap can further preferably be produced at the same time by way of a primary forming production method. A support reinforcement can be provided at the base of at least one connecting pin (preferably of each load-bearing connecting pin), which support reinforcement can be connected to the dome cap in an integrally joined manner. This is preferably a thickened material portion in the region of the connecting pins which configure the transition to the dome cap. The support reinforcements are preferably shaped in such a way that forces which act on the connecting pins can be introduced satisfactorily into the liner and/or into the fiber-reinforced layer. The support reinforcement advantageously widens toward the surface of the dome cap. Consequently, the connecting pin therefore has a lesser thickness at its free end than at its base which is connected to the dome cap. Therefore, stress concentrations in the transition from the connecting pins to the dome cap can be reduced.

At least one connecting pin is particularly preferably configured to transmit external loads from a vehicle body of the motor vehicle into the liner and/or into the fiber-reinforced layer of the pressure vessel. To this end, in the installed position of the pressure vessel, at least one part region of at least one connecting pin is preferably coupled directly or indirectly to the vehicle body, with the result that forces can be transmitted. For example, to this end, the connecting pin can have an internal and/or external thread. A fixing mechanism can further preferably be provided for coupling the at least one connecting pin, as disclosed in the German patent application of the Applicant with the application number DE 10 2015 206825.0. The fixing mechanism of DE 10 2015 206825.0 (designations 143, 144; 143′, 144′ therein), its functional arrangement, the interaction with the connecting pin, and the connecting pin itself are hereby expressly incorporated by reference herein. The fastening apparatus of the German patent application of the Applicant DE 102015206826.9 (designations 140, 140′ therein) is likewise hereby expressly incorporated by reference herein.

By way of the technology which is disclosed herein, it is advantageously possible to transmit forces and torques from the vehicle body into the pressure vessel. The overall rigidity of the motor vehicle can therefore be increased significantly in a manner which is inexpensive, approximately weight-neutral and associated with a small installation space requirement.

Furthermore, the technology which is disclosed herein relates to a motor vehicle, in particular a two-track motor vehicle, having a pressure vessel as disclosed herein. The connecting pins of the pressure vessel can advantageously be coupled to vehicle body attaching elements (for example, the above-mentioned fixing mechanism) of the motor vehicle in such a way that forces and/or torques can be transmitted from the vehicle body into the pressure vessel. The pressure vessel (in particular, the at least one dome cap, the liner and the fiber-reinforced layer) can be configured to transmit forces and/or torques which are greater in terms of magnitude, for example at least by a factor of 2.5, 4, 8, 10, 20 or 100, than the forces and/or torques which result during operation from the mass of the pressure vessel and the fuel which is contained therein (for example, weight force, transverse acceleration, etc.). In each case one dome cap is preferably provided at both ends of the at least one pressure vessel. In this way, forces can advantageously be introduced at a first end P₁ of the pressure vessel from the vehicle body into the pressure vessel, and can be dissipated at the second end P₂ of the pressure vessel into the vehicle body again. The pressure vessel can therefore be configured as a load-bearing pressure vessel or as a reinforcing element of the vehicle body.

Furthermore, the dome cap can have bolts which likewise project to the outside from the surface of the dome cap. The bolts preferably do not protrude out of the fiber-reinforced layer. The bolts can serve, in particular, to introduce the forces into the fiber-reinforced layer, which forces were introduced via the connecting pins in the dome cap. The bolts are preferably shorter and/or thinner than the connecting pins. In this way, the weight and material costs of the dome cap can advantageously be reduced.

The connecting pins and/or the bolts are preferably arranged in such a way that more reinforcing fibers of the fiber-reinforced layer can be laid on the end/ends in the circumferential direction U than in the case of a configuration without connecting pins and/or bolts. In other words, the connecting pins and/or bolts can be configured and arranged in such a way that they act as winding and/or weaving aids, by rovings being supported laterally and therefore being saved from sliding off even in the case, for example, of being deposited in a non-geodetic manner. The connecting pins and/or the bolts are preferably arranged concentrically or substantially concentrically around the opening of the liner.

The bolts and/or the connecting pins are particularly preferably arranged spaced apart from the opening of the pressure vessel. For example, the bolts and/or the connecting pins can be arranged spaced apart from the center longitudinal axis A-A in the radial direction by at least 100 mm, preferably by at least 150 mm or by at least 200 mm. The bolts and/or the connecting pins can further preferably be arranged spaced apart in the radial direction from the outer circumference of the neck of the pressure vessel by at least 30 mm, preferably by at least 50 mm or by at least 100 mm. For example, bolts can be distributed over the entire area of the dome. The connecting pins can preferably be arranged spaced apart from the center longitudinal axis A-A in the radial direction at least by half the external radius, preferably at least by two thirds of the external radius. Here, the external radius is the mean radius which the liner has in the (substantially) cylindrical shell region M. If the bolts and/or connecting pins are arranged in a manner which is spaced apart, forces and/or torques can be introduced into the pressure vessel in a particularly satisfactory manner.

In addition to a circular cross-sectional geometry, the connecting pins and/or bolts can also have different cross-sectional geometries (for example, oval or elongate cross-sectional geometries). They are configured and arranged, in particular, in such a way that fibers of the fiber-reinforced layer can run between adjacent bolts and connecting pins.

The dome cap can be configured, in particular, in one piece with a port of the pressure vessel. In other words, the dome cap itself can serve to connect any fuel lines to the pressure vessel. The dome cap can therefore have, for example, a neck, to which a fuel line can be flange-connected. In this context, in one piece means that the dome cap is produced from one material.

The dome cap can lie directly or indirectly on the liner and/or possibly on the boss at least in regions. In this context, indirect means that at least one intermediate layer can be arranged between the dome cap and the liner and/or port. Said intermediate layer can serve, for example, to prevent contact corrosion between two metal materials. An intermediate layer can also serve to fix the dome cap during the weaving and/or winding process. A fiber-reinforced layer might likewise be used as an intermediate layer.

Furthermore, the technology which is disclosed herein relates to a method for producing a pressure vessel. The method comprises the steps: (i) provision of a liner for storing fuel; (ii) provision of at least one dome cap, the dome cap and the liner being configured as disclosed herein; and (iii) application of a fiber-reinforced layer, the fiber-reinforced layer covering the dome cap at least partially, and the connecting pins of the dome cap projecting out of the fiber-reinforced layer.

The fiber-reinforced layer or encapsulation is as a rule produced in a winding process and/or in a weaving process. The thickness of the fiber-reinforced layer is preferably lower at least in regions than the length of at least two connecting pins, with the result that, in the installed position of the pressure tank, the connecting pins can be coupled directly or indirectly to the vehicle body.

The technology which is disclosed herein provides a component for introducing mechanical loads into the fiber composite material reinforcement of a pressure vessel within the dome regions. It is a rigid dome-shaped shell or dome cap with a multiplicity of bolts which are arranged perpendicularly on the convex surface and penetrate the laminate (=fiber-reinforced layer) from the inside to the outside over its entire thickness. Some of these bolts are embodied as stronger connecting pins, which are arranged concentrically with the pole opening and by means of which mechanical load can be introduced from the outside into the pressure vessel. The connecting pins are expediently made from solid material, the length of which can protrude beyond the surface of the laminate with an internal and/or external thread. Therefore, the introduction of tensile, compressive and torsional loads can take place via a positively locking and screwed attachment, for example. The further bolts can introduce the load into the CFRP reinforcement in a manner which is distributed uniformly over the entire area of the dome cap, and can therefore reduce the stress peaks at the load introduction points. Excessively high stress peaks, and therefore the risk of material damage, can be reduced or avoided.

In the embodiment as a pure dome cap for load introduction, the shell can be designed structurally, for example, as a framework made from metallic or fiber composite material. In particular, the dome cap itself can be formed from a fiber-reinforced layer. At least one layer of the reinforcing fibers in the dome cap is preferably oriented in the circumferential direction U. For the present case, further variants are also contemplated which aid the load introduction via the connecting pins into the laminate. In order to transmit the shear stresses which occur in the case of the introduction of torsional load, a draped ±45° roving is advantageous as the material for at least one ply of the dome cap. Depending on the requirement, the dome cap can be designed with a fiber orientation between the two extreme cases of “circumferential direction” and “±45°”, or can also be designed with a multiple-ply multi-axial construction.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a cross-sectional view of a pressure vessel.

FIG. 2 is a further cross-sectional view of a pressure vessel.

FIG. 3 is a cross-sectional view of a dome cap 130.

FIG. 4 is a perspective view of a dome cap 130.

### DETAILED DESCRIPTION OF THE DRAWINGS

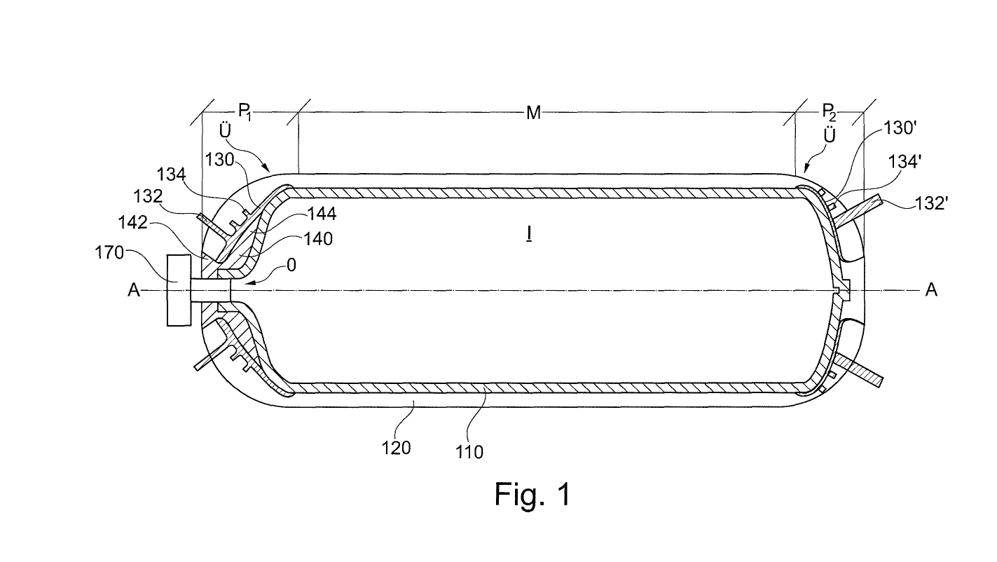

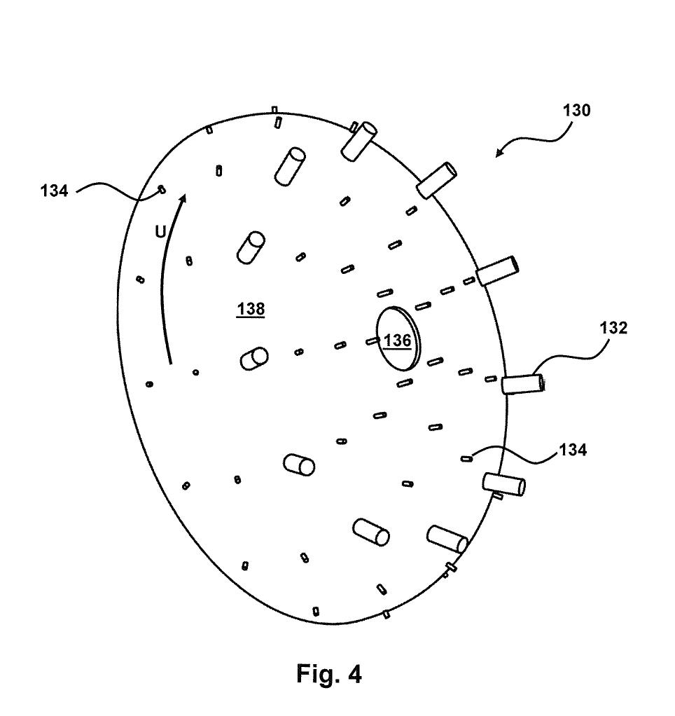

FIG. 1 shows a partial cross section of a pressure vessel with a liner 110 and a fiber-reinforced layer 120. The liner 110 forms a storage volume 1 for the fuel. An outlet or an opening O for the stored fuel is provided at the front end P₁. This opening O and the port 140 are not to be considered to be a connecting pin 132. The connecting pins 132 project from the surface 138 (cf. FIG. 4) of the dome cap 130. The connecting pins 132 can have a support reinforcement (not shown) at the base of the connecting pins 132. Here, the connecting pins 132 are configured in one piece with the dome cap 130 which bears partially against the connecting section 144 from the port 140 and partially against the liner 110 here. Here, the dome cap 130 protrudes into the shell region M of the pressure vessel or the liner 110. Here, the dome cap 130 is covered completely by the fiber-reinforced layer 120. Merely the connecting pins 132 protrude out of the fiber-reinforced layer 120. The protruding part of the connecting pins 132 advantageously serves to couple the pressure vessel to the vehicle body (not shown). The port 140 has a neck 142, in which a further connector element 170 is inserted here. Adjacently with respect to the connecting pins 132, bolts 134 can likewise be arranged spaced apart radially from the port. If forces and torques are then transmitted by the vehicle body (not shown) to the connecting pins 132, said forces and torques are partially introduced directly into the fiber-reinforced layer. The dome cap section between the respective connecting pins 132 and bolts 134 can also transmit said forces and torques at least partially to the bolts 134. The bolts 134 then introduce the forces and/or torques into the fiber-reinforced layer 120 in a non-positive manner. Furthermore, the dome cap section introduces a part of the forces and torques into the fiber-reinforced layer 120 in an integrally joined manner. The forces and torques which are transmitted by the vehicle body are therefore introduced partially by way of the connecting pins 132 and bolts 134, in each case in a positively locking manner, and by way of the surface of the dome cap section, in an integrally joined manner, into the fiber-reinforced layer 120. The forces and torques are therefore introduced comparatively extensively into the fiber-reinforced layer 120. Punctiform loads are reduced. Comparatively high forces and torques can therefore be transmitted overall with a low pressure vessel weight at the same time. Furthermore, the construction which is disclosed herein can be produced comparatively simply and therefore inexpensively. The dome cap 130 itself additionally reinforces the pole cap with regard to forces which result from the vessel interior pressure. If, for example, a dome cap 130 made from a fiber-reinforced plastic is used, the fibers in the laminate can advantageously be arranged in the circumferential direction (cf. FIG. 4). A blind boss is provided at the second end P₂. Here, the dome cap 130′ bears predominantly against the liner 110. Otherwise, the dome cap 130′ corresponds substantially to the dome cap 130.

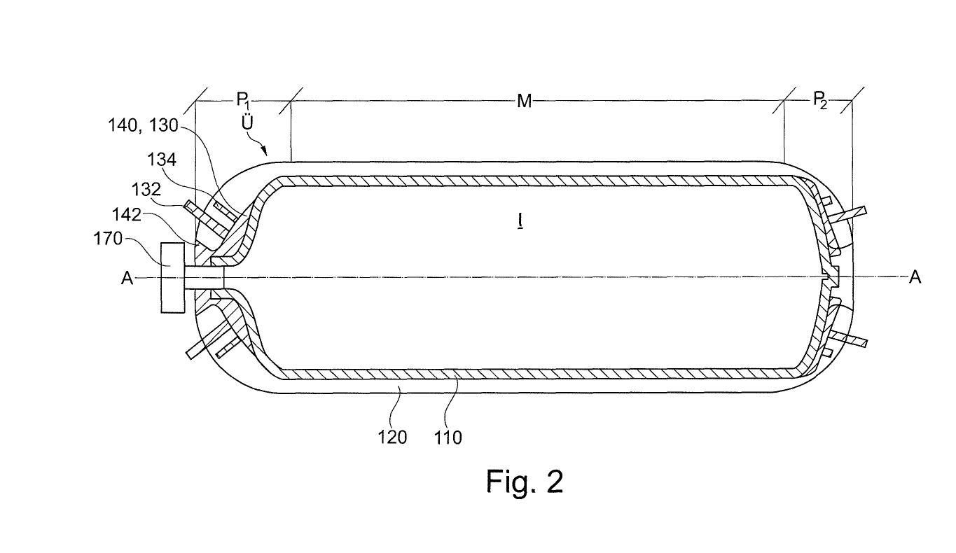

FIG. 2 shows a further refinement of the pressure vessel. In the following text, only the differences in comparison with the embodiment in accordance with FIG. 1 will be described. All other features are substantially identical. The pressure vessel which is shown here has a dome cap 130, into which the boss or port 140 is also integrated. The dome cap 130 therefore also comprises the collar section or neck section 142, into which the connector element 170 can be introduced. Toward the cylindrical shell region, the dome cap 130 already ends here in the transition region Ü. A bevel is provided on the edge which is provided there, with the result that the transition to the fiber reinforced layer is as harmonic as possible (as is also the case in FIG. 1).

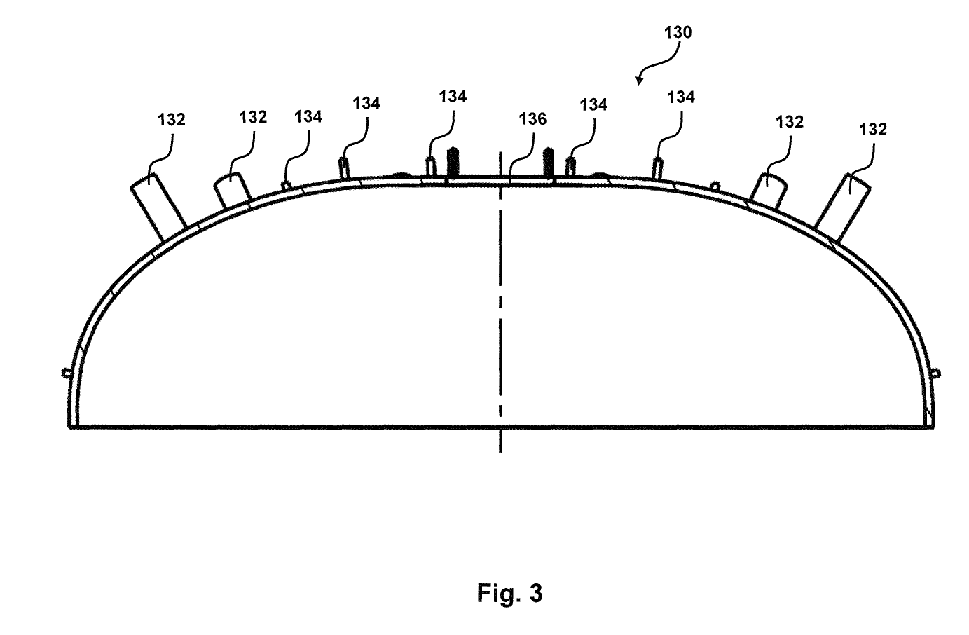

FIG. 3 shows a cross-sectional view of a dome cap 130, as can be used, for example, in the pressure vessel of FIG. 1. The connecting pins 132 project perpendicularly to the outside from the surface 138 of the dome cap 130. Here, the dome cap 130 is formed from an aluminum sheet. Other materials can likewise be used, however. Here, the dome cap has a circular base area. The opening 136 is provided in the center.

FIG. 4 shows a perspective view of the dome cap 130, in which view the circumferential direction is additionally plotted.

FIGS. 1 to 4 show an elongate pressure vessel which has a cylindrical region M and correspondingly curved ends P₁, P₂. Other pressure vessel shapes are also contemplated, however, and are also included by the technology which is disclosed herein. For example, the pressure vessel can have an elliptical basic shape. The cylindrical region M can also be of more bulbous configuration. The diameter might then vary in the cylindrical region M. The pressure vessel might also not be of rotationally symmetrical configuration.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF DESIGNATIONS

Liner 110
Fiber-reinforced layer 120
Dome cap 130
Connecting pins 132
Bolt 134
Cap opening 136
Surface 138
Boss/Port 140
Neck 142
Connecting section 144
Connector element 170
Opening O
Pressure vessel longitudinal axis A-A
Circumferential direction U
Shell region M
End, pole cap region P1, P2
Transition region Û

What is claimed is:

1. A pressure vessel for storing fuel, comprising:
a liner configured to store the fuel;
a fiber-reinforced layer surrounding at least some areas of the liner;
at least one dome cap which at least partially covers one end of the liner; and
connecting pins projecting from a surface of the dome cap, wherein the connecting pins protrude out of the fiber-reinforced layer.

2. The pressure vessel as claimed in claim 1, wherein the dome cap further comprises:
bolts which likewise project from the surface of the dome cap.

3. The pressure vessel as claimed in claim 2, wherein
the dome cap is configured in one piece with a port of the pressure vessel.

4. The pressure vessel as claimed in claim 3, wherein
the dome cap has at least one laminate layer, fibers of at least one ply of the laminate layer being oriented in the circumferential direction.

5. The pressure vessel as claimed in claim 4, wherein
the dome cap bears directly or indirectly at least in regions against the liner and/or against a port.

6. The pressure vessel as claimed in claim 5, wherein
the connecting pins and/or the bolts are arranged concentrically with a center longitudinal axis of the pressure vessel.

7. The pressure vessel as claimed in claim 1, wherein
the dome cap is configured in one piece with a port of the pressure vessel.

8. The pressure vessel as claimed in claim 1, wherein
the dome cap has at least one laminate layer, fibers of at least one ply of the laminate layer being oriented in the circumferential direction.

9. The pressure vessel as claimed in claim 1, wherein
the dome cap bears directly or indirectly at least in regions against the liner and/or against a port.

10. The pressure vessel as claimed in claim 2, wherein
the connecting pins and/or the bolts are arranged concentrically with a center longitudinal axis of the pressure vessel.

11. A motor vehicle, comprising:
at least one pressure vessel as claimed in claim 1, wherein
the connecting pins of the pressure vessel are coupled to vehicle body attaching elements of the motor vehicle such that forces and/or torques are transmittable from the vehicle body into the pressure vessel.

12. The motor vehicle as claimed in claim 11, wherein
in each case one dome cap is provided at both ends of the at least one pressure vessel.

13. A method for producing a pressure vessel, the method comprising the steps of:
providing a liner for storing fuel and at least one dome cap, the dome cap covering one end of the liner at least partially; and
applying a fiber-reinforced layer, the fiber-reinforced layer covering the dome cap at least partially, wherein connecting pins of the dome cap protrude out of the fiber-reinforced layer.
